(19) United States
(12) Patent Application Publication
(10) Pub. No.: US 2024/0183192 A1
(43) Pub. Date: Jun. 6, 2024

(54) DEVICE AND METHOD FOR UNLOCKING AN ELECTROMECHANICAL LOCK

(71) Applicant: Swedlock AB, Halmstad (SE)

(72) Inventors: Johan Hörberg, Halmstad (SE); Martin Lindvall, Simlångsdalen (SE)

(73) Assignee: Swedlock AB, Halmstad (SE)

(21) Appl. No.: 18/556,252

(22) PCT Filed: Apr. 7, 2022
(86) PCT No.: PCT/SE2022/050352

§ 371 Date: Oct. 19, 2023

(30) Foreign Application Priority Data
Apr. 23, 2021 (SE) 2150515-1

(51) Int. Cl. E05B 17/22; E05B 11/00; E05B 47/00

(52) U.S. Cl. CPC E05B 17/22; E05B 11/005; E05B 47/0001; E05B 2047/0084; E05B 2047/0095

(57) ABSTRACT

A lock operating device (100) configured to be retrofitted on an electromechanical lock (200) having a key-receiving portion (210) is provided. The lock operating device (100) comprises a maneuver knob (110) and a key blade (120) being operably connected to the maneuver knob (110) and being insertable in said key-receiving portion (210) of the electromechanical lock (200), and circuitry (130) which includes wireless communication means (132) arranged to wirelessly receive authentication information, and which circuitry (130) is arranged to communicate the received authentication information to the electromechanical lock (200) via the inserted key blade (120). The lock operating device (100) thereby allows conversion of the electromechanical lock (200) from a first operating mode, in which the electromechanical lock (200) can be operated by a programmable physical key receivable in said key-receiving portion (210), to a second operating mode in which the electromechanical lock (200) is arranged to receive said authentication information wirelessly and be operated by the maneuver knob (110).

### TECHNICAL FIELD

The present disclosure belongs to devices and methods for unlocking an electromechanical lock.

### BACKGROUND

Locks based on wireless communication protocols have been grown popular recently. One such emerging protocol is near field communication, NFC, as of the advent of implementation of NFC in smartphones. NFC may allow not only encrypted authentication information to be wirelessly transmitted to enable unlocking of the lock, but also electrical power to be wirelessly transmitted to supply the circuitry of the lock. Such a lock may be fully electric in that a user may unlock the lock by simply holding a smartphone close to an NFC receiver of the lock, provided the smartphone is equipped with appropriate access rights. Alternatively, such a lock may be electromechanical in that the user may employ a similar procedure followed by subsequently rotating a knob of the lock to complete the unlocking of the lock.

Other recent locking systems include an electromechanical lock and a programmable key for unlocking the electromechanical lock. The programmable key thereby needs to have a valid stored access right to unlock a specific such an electromechanical lock.

Despite the benefits associated with respective above locking system, there may be situations when it is desirable to conveniently switch between these locking systems. Alternatively, there may be situations when it is desirable to convert a presently installed programmable-key based electromechanical lock in favor of an NFC based locking system, or vice versa.

Hence, there is a need for a more flexible solution providing an approach for resolving these situations.

### SUMMARY

Thus, it is an object of the invention to provide a flexible solution to unlock an electromechanical lock

According to a first aspect of the invention, there is provided a lock operating device configured to be retrofitted on an electromechanical lock having a key-receiving portion, said lock operating device comprising:

a maneuver knob, a key blade being operably connected to the maneuver knob and being insertable in said key-receiving portion of the electromechanical lock, and circuitry which includes wireless communication means arranged to wirelessly receive authentication information, and which circuitry is arranged to communicate the received authentication information to the electromechanical lock via the inserted key blade, wherein the lock operating device thereby allows conversion of the electromechanical lock from a first operating mode, in which the electromechanical lock can be operated by a programmable physical key receivable in said key-receiving portion, to a second operating mode in which the electromechanical lock is arranged to receive said authentication information wirelessly and be operated by the maneuver knob.

Hence, provided an electromechanical lock, configured to be unlockable by a programmable key, has been installed on, e.g., a building door or a room door, the electromechanical lock is selectively convertible to be unlockable utilizing wireless means by inserting the lock operating device into the electromechanical lock. This may provide flexibility of the electromechanical lock, to thereby be selectively operated by different unlocking means. A further advantage may be that if a programmable physical key operated electromechanical lock has been previously installed, to be presently replaced by wireless unlocking techniques, the present disclosure may offer an economical and convenient add-on for such a purpose.

The wording “unlockable” herein refers to a state of the electromechanical lock where necessary valid authentication information for unlocking the electromechanical lock has been received such that it is possible to unlock the electromechanical lock by, e.g., rotating the maneuver knob.

The wording “operably connected” may include any one of directly attached, indirectly attached, and connected such that a movement of the maneuver knob generates a movement of the key blade. The latter case may thereby include a clockwise rotation of the key blade while rotating the maneuver knob counterclockwise, or the like.

The occasionally referenced programmable physical key above and below, may generally comprise a key blade, circuitry comprising authentication information, and electrical power means such as a rechargeable battery. Transmission of authentication information and electrical power may occur via the key blade of the programmable physical key. Hence, the programmable physical key is configured to unlock the electromechanical lock, provided the circuitry of the programmable key comprises valid access rights.

The lock operating device may serve, when inserted in the electromechanical lock, to forward authentication information from an electronic device to the electromechanical lock. The lock operating device may receive authentication information wirelessly from the electronic device and forwards the authentication information, via the key blade, to the electromechanical lock. The electronic device may be a smartphone. Hence, the lock operating device may exclude a need for a programmable physical key for unlocking the electromechanical lock.

It is to be noted that, from a security aspect, the lock operating device may exclusively serve to forward authentication information from the electronic device to the electromechanical lock. That is, the lock operating device may not itself contain authentication information, e.g., valid access rights such as encrypted cipher keys, decipher keys, or the like. Hence, no additional security risk may be present should the lock operating device be acquired by a third participant having possibly malicious intent.

The circuitry may be arranged to transmit electrical power to the electromechanical lock.

Electrical power as used herein refers to an electrical current or an electrical potential difference capable of generating an electrical current. Such an electrical power may for example execute an actuator to be physically moved inside the electromechanical lock, or the like.

The key blade may comprise fastening means arranged to mechanically fasten the key blade within the key-receiving portion in a fastened state which thereby may prevent unauthorized separation of the lock operating device from the electromechanical lock.

The fastening means may allow to securely fasten the lock operating device to the electromechanical lock. The fastening means may by way of example include a screw to be fastened between the knob and a lock cylinder of the electromechanical lock. The wording “unauthorized separation” as used herein is to be understood as an undesired removal of the lock operating device from the electromechanical lock. Such an undesired removal may include removal of the lock operating device by, e.g., an innocent child, a saboteur, or the like.

The lock operating device and the electromechanical lock may be arranged to be fastened in the fastened state in response to locking the electromechanical lock.

This may provide additional flexibility in that a user may conveniently remove the lock operating device when the electromechanical lock is in an unlocked state. Conversely, while the electromechanical lock is in a locked state, the lock operating device may be securely fastened to prevent unauthorized removal of the lock operating device by a saboteur, or the like. The key blade may comprise an indentation for receiving a geometrically complementary element located in the electromechanical lock, the indentation and the geometrically complementary element being arranged to retain the lock operating device and the electromechanical lock in a retained state while the key blade is inserted in the key-receiving portion, wherein the retained state is such that the lock operating device can be unauthorizedly separated from the electromechanical lock by applying at least a threshold force along an axial extension of the key blade.

This may provide the lock operating device to be firmly retained in the electromechanical lock when the key blade of the lock operating device is inserted in the electromechanical lock. The indentation of the key blade may have any adequate geometry to receive the geometrically complementary element of the electromechanical lock. The geometrically complementary element may be a flexible arm having a protrusion that at least partly is to be received by the indentation. Alternatively, the geometrically complementary element may be a spring-loaded ball, or the like. Conversely, an opposite arrangement is possible. That is, the key blade may comprise either of the described complementary elements, whereas the indentation is located in the electromechanical lock. This may enhance simplicity in retaining the lock operating device in the electromechanical lock, which thereby may reduce cost for an end user, as well as preventing mechanical failure.

The circuitry may be arranged to wirelessly transmit electrical power from an electronic device to the electromechanical lock.

Such a so-called energy harvesting by the lock operating device from the electronic device to the electromechanical lock may allow the electromechanical lock to be unpowered unless the electromechanical lock is to be unlocked according to an unlocking procedure further described below. Security may hence be enhanced in the event the electromechanical lock is electrically unpowered.

The circuitry may comprise Near Field Communication, NFC, means to allow either or both of authentication information and electrical power to be wirelessly transmitted from the electronic device to the electromechanical lock.

Provision of forwarding either or both of authentication information and electrical power by NFC means may enhance convenience for a user. Unlocking of the electromechanical lock may then be done by a smartphone, thereby reducing a need of a physical programmable key. Further, exclusion of any additional built-in wireless communication means in the lock operating device, such as Wi-Fi or the like, may facilitate security, as remote hacking possibilities by a third participant having a possibly malicious intent may be reduced or eliminated. Further, by wirelessly transmit electrical power from the electronic device and the electromechanical lock may allow the electromechanical lock to be temporarily powered by the electronic device via the lock operating device. Hence, the electromechanical lock may be unpowered unless the electronic device is located within a distance of the NFC range from the lock operating device, which is typically approximately 10 cm, and, additionally, the electromechanical lock is to be unlocked by the electronic device. Such an absence of power of the electromechanical lock may further enhance security, as the electromechanical lock then lack remote hacking possibilities by a third participant having a possibly malicious intent. Data transfer by NFC means may further provide a fast transmission of authentication information, thereby reducing time for locking/unlocking the electromechanical lock.

The lock operating device may comprise a battery or an electric generator.

This may enable powering of the electromechanical lock by the lock operating device. Hence, the electromechanical lock may be unlocked by, e.g., Bluetooth, Bluetooth low energy, a passive RFID tag, or the like, thereby facilitating additional flexibility.

According to a second aspect of the invention, there is provided a lock operating system lock operating system, comprising an electromechanical lock having a key-receiving portion, and a lock operating device according to the first aspect of the invention.

An electromechanical lock, previously installed on, e.g., a door of a building to be unlocked by a programmable physical key, is thereby to be unlocked wirelessly by inserting a key blade of the lock operating device into a key-receiving portion of the electromechanical lock. Hence, this may facilitate flexibility of the electromechanical lock, to thereby be operated by selectively different unlocking means.

The above-mentioned features and advantages of the lock operating device, when applicable, apply to this second aspect as well. In order to avoid undue repetition in connection with some of the below embodiments, reference is made to the above.

The key blade may comprise fastening means arranged to mutually fasten the lock operating device and the electromechanical lock in a mutually fastened state, thereby preventing unauthorized separation of the lock operating device and the electromechanical lock.

The key blade may comprise a key-blade fastening element according to the above. The electromechanical lock may comprise a complementary fastening element complementary to the key-blade fastening element, for setting the lock operating device and the electromechanical lock in a mutually fastened state in response to locking the electromechanical lock, thereby preventing unauthorized separation of the lock operating device and the electromechanical lock.

The electromechanical lock may comprise a first configuration screw, a second configuration screw and a lock cylinder. The complementary fastening element may be biased in a radial direction of the lock cylinder provided the complementary fastening element is radially aligned with the first configuration screw and the key blade is inserted in the lock cylinder, wherein the complementary fastening element is non-movable in the radial direction of the lock cylinder provided the complementary fastening element is radially aligned with the second configuration screw and the key blade is inserted in the lock cylinder. The lock operating device and the electromechanical lock may thereby be mutually fastened while the fastening element is non-movable in the radial direction of the lock cylinder.

This may facilitate fastening of the key blade in the electromechanical lock in a mechanically convenient and secure manner.

The key blade may comprise a key-blade fastening element for receiving a fastening element of the electromechanical lock to fasten the lock operating device and the electromechanical lock in a mutually fastened state, the fastening element of the electromechanical lock being actuated in response to receiving valid authentication information from the electronic device.

The key blade may comprise an indentation according to the above, and the key-receiving portion may comprise a geometrically complementary element, the indentation and the geometrically complementary element being arranged to be mutually retained in a mutually retained state while the key blade is inserted state in the key-receiving portion, wherein the mutually retained state is such that the lock operating device can be unauthorizedly separated from the electromechanical lock by applying at least a threshold force on the lock operating device, the threshold force being parallel to an axial extension of the key blade.

The threshold force is to be understood possibly having a first component being parallel to the axial extension of the key blade, and a second component being perpendicular to the axial extension of the key blade. In practice, the second component may be small compared to the first component. This since a key blade is normally inserted or pulled out substantially along an axial extension of the key blade.

The circuitry of the lock operating device may be configured to wirelessly transmit electrical power from the electronic device to the electromechanical lock.

Such a so-called energy harvesting from the electronic device to the electromechanical lock may allow the electromechanical lock to be unpowered unless the electromechanical lock is to be unlocked according to an unlocking procedure, described above and below. In case the lock operating device is to be separated from the electromechanical lock to thereby be operated by a physical programmable key, the electromechanical lock may be powered by the physical programmable key while the key blade of the physical programmable key is in an inserted position in the key-receiving portion of the electromechanical lock. The power transmission from either the key blade of the lock operating device or the key blade of the physical programmable key may occur via solenoid-based techniques, i.e., a variable magnetic field for inducing an electrical current. A solenoid may in such situations be located in proximity to the tip of the key blade. This may provide a reliable power transmission of electrical power which may be less sensitive to whether physical contact between the key blade and the electromechanical lock has been established.

The circuitry of the lock operating device may comprise Near Field

Communication, NFC, means to allow either or both of authentication information and electrical power to be wirelessly transmitted between the electronic device and the electromechanical lock.

The electromechanical lock may, provided the electromechanical lock has received valid authentication information from the electronic device, be arranged to be set in an unlocked state by rotating the lock operating device about the axial extension of the key blade when the key blade is inserted in the key-receiving portion.

By prompting a user to, by manual power, rotate the knob of the lock operating device to unlock the electromechanical lock may facilitate a reduced amount of required electrical power to unlock the electromechanical lock. Hence, electrical power may be saved, and the involved circuitry may be relatively compactly sized.

According to a third aspect of the invention, there is provided a method for converting an electromechanical lock from a first operating mode in which the electromechanical lock can be operated by a programmable physical key receivable in a key-receiving portion of the electromechanical lock, to a second operating mode, said method comprising:

inserting a key blade of a lock operating device into said key-receiving portion, said lock operating device comprising circuitry which includes wireless communication means arranged to wirelessly receive authentication information, and which circuitry is arranged to communicate the received authentication information to the electromechanical lock via the inserted key blade.

The above-mentioned features and advantages in connection with the first and the second aspect, when applicable, apply to this third aspect as well. In order to avoid undue repetition, reference is made to the above.

The method may further comprise transmitting electrical power to the electromechanical lock.

The method may further comprise wirelessly transmitting authentication information between an electronic device and the lock operating device.

The method may further comprise rotating a maneuver knob of the lock operating device about an axial extension of the key blade for unlocking the electromechanical lock.

The method may further comprise fastening the lock operating device to the electromechanical lock in a mutually fastened state to prevent unauthorized separation of the lock operating device and the electromechanical lock.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments, with reference to the appended drawings, where the same reference numerals will be used for similar elements, wherein:

FIG. 1 schematically shows a lock operating device.

FIG. 2A schematically shows a lock operating system when a lock operating device is inserted in an electromechanical lock.

FIG. 2B schematically shows a lock operating system when a lock operating device is spatially separated from an electromechanical lock.

FIG. 3 schematically shows an example of fastening a key blade in an electromechanical lock.

FIG. 4 schematically shows an example of attaching a key blade in an electromechanical lock.

FIG. 5 pictorially shows a locking procedure of an electromechanical lock using a lock operating device.

FIG. 6 describes a method for converting an electromechanical lock between being operated wirelessly and being operated by a programmable physical key.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and to fully convey the scope of the invention to the skilled person.

Unless nothing else is stated, an axial extension refers to a direction substantially parallel to an axial extension of a lock cylinder. Hence, an axial extension of a key blade substantially coincides with the axial extension of the lock cylinder upon insertion of the key blade in the lock cylinder, or when the key blade is inserted in the lock cylinder. The axial extension of the key blade may however occasionally be referenced in isolation, which should be readily appreciated by a person skilled in the art. A front side of a device or a system as described below, refers to a side facing a user upon unlocking an electromechanical lock, unless not stated otherwise.

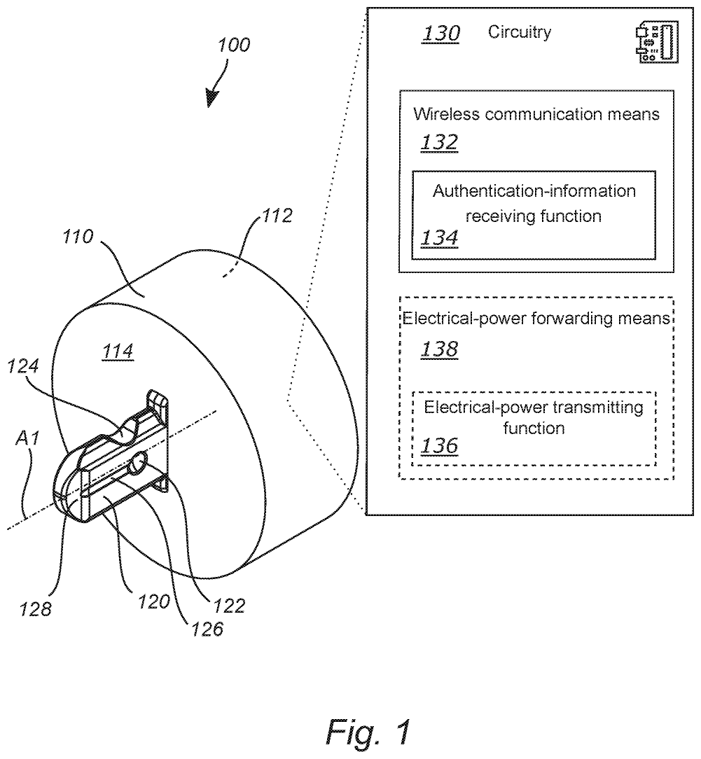

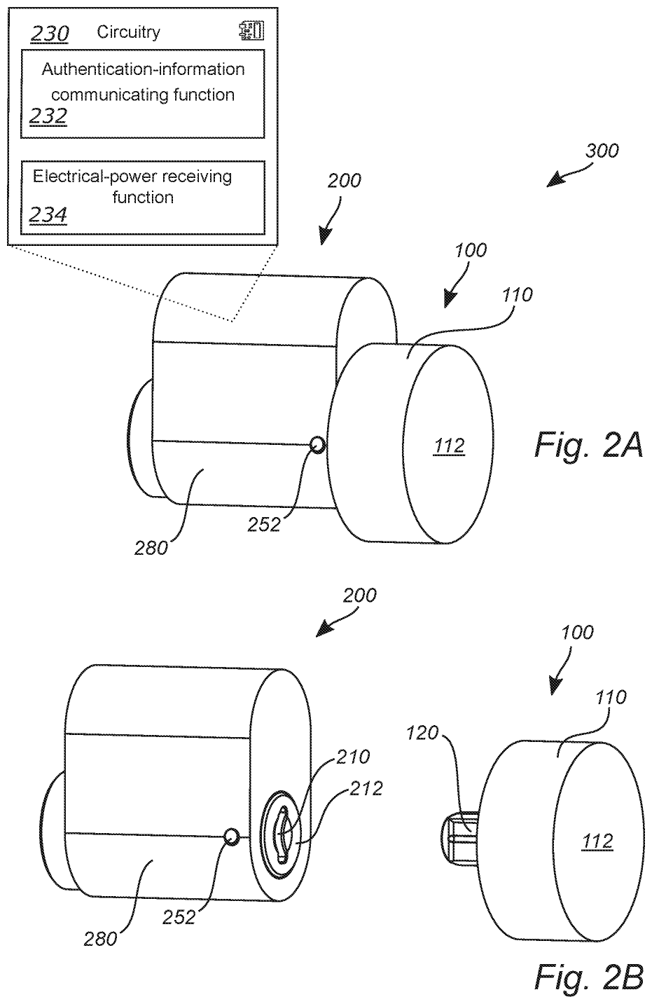

In connection with FIG. 1 there is shown a lock operating device 100. FIG. 2 may advantageously be viewed along with the description of FIG. 1 below. The lock operating device 100 is configured to be retrofitted on an electromechanical lock 200. The wording “retrofitted” as used herein, is to be understood as the lock operating device 100 being, by a user, selectively attachable or removable onto/from an electromechanical lock 200; see FIG. 2. The electromechanical lock 200 comprises a key-receiving portion 210. The lock operating device 100 comprises a maneuver knob 120. The lock operating device 100 comprises a key blade 120. The key blade 120 is operably connected to the maneuver knob 110. The maneuver knob 110 is insertable in the key-receiving portion 210 of the electromechanical lock 200. The maneuver knob 110 may have any adequate geometry. The maneuver knob 110 may be rotatable when the key blade 120 is inserted in the key-receiving portion 210. The maneuver knob 110 may be substantially cylindrical, as schematically shown in FIG. 1. Any other suitable geometry of the maneuver knob 110 may however be possible within the scope of the claims.

The lock operating device 100 comprises circuitry 130. The circuitry 130 may be located in the maneuver knob 110. Alternatively, the circuitry 130 may be located in the key blade 120. Alternatively, at least a portion of the circuitry 130 may be located in the maneuver knob 110 and a remaining portion of the circuitry 130 may be located in the key blade 110. The circuitry 130 includes wireless communication means 132. The wireless communication means 132 is arranged to wirelessly receive authentication information. Hence, the circuitry 130 comprises an authentication-information receiving function 134. The circuitry 130 is arranged to communicate the received authentication information to the electromechanical lock 200 via the inserted key blade 120. Any suitable authentication procedure may be possible. By way of example, the authentication procedure may include a two-step verification, a handshake verification, or the like. The circuitry 130 of a specific lock operating device 100 may be configured for allowing unlocking a plurality of electromechanical locks, wherein respective electromechanical lock is associated with a specific access right. Thus, a lock operating device 100 as disclosed herein may be essentially identical to any other lock operating device 100 configured to allow unlocking an electromechanical lock 200. Further, the lock operating device 100 may not on its own unlock an electromechanical lock 200, as the lock operating device 100 solely aims to forward authentication information and possibly electrical current or generating a potential difference to generate an electrical current. In other words, the lock operating device 100 may not function as a key on its own for unlocking the electromechanical lock 200. The lock operating device 100 allows conversion of the electromechanical lock 200 from a first operating mode, in which the electromechanical lock 200 can be unlocked by a programmable physical key receivable in the key-receiving portion 210, to a second operating mode in which the electromechanical lock 200 is arranged to receive the authentication information wirelessly and be unlocked by the maneuver knob 110. The lock operating device 100 is selectively detachable. Accordingly, the lock operating device 100 allows conversion of the electromechanical lock 200 from the second operating mode to the first operating mode. Hence, the lock operating device 100 may be viewed as a lock conversion device.

The circuitry 130 may be arranged to transmit electrical power to the electromechanical lock 200. Hence, the circuitry 130 may comprise an electrical-power transmitting function 136. The circuitry 130 may be configured to transmit electrical power from the electronic device and the electromechanical lock 200. Alternatively, the lock operating device 100 may comprise a battery. The lock operating device 100 may comprise a battery to be wirelessly recharged by an electronic device. Alternatively, the lock operating device 100 may comprise an electrical generator for powering the electromechanical lock 200. The battery or the electrical generator may in such a situation be located in the maneuver knob 110. In the event the lock operating device 100 comprises a battery or an electrical generator, the electromechanical lock 200 may, via the lock operating device 100, be locked and unlocked, or, at least be set in an unlockable state by the electronic device using Bluetooth, Bluetooth low energy, or the like. Alternatively, the electromechanical lock 200 may in such a situation, via the lock operating device 100, be operated by a passive radio-frequency identification (RFID) tag, or any similar technique.

The electronic device may be any adequate device configured to transmit authentication information wirelessly. The electronic device may be a smart device, where “smart” refers to its presently ordinary meaning. Preferably, the electronic device may be a smartphone. The authentication information may be associated with a smartphone application. The electronic device may be any future equivalent of a smartphone as known at the date of filing of this application. Other examples of adequate electronic devices to be used within the present disclosure may be a smart watch, a smart ring, a tablet, a key tag, or a keycard. The electronic device may be any adequate device configured to transmit electrical power wirelessly to another device. However, this feature may be redundant in the event the lock operating device 100 comprises a built-in power source, such as a battery. In such a situation, as set out above, the electronic device may be, e.g., a passive RFID tag, or the like. The electronic device may be any adequate device configured to transmit authentication information and electrical power wirelessly to another device.

The key blade 120 may be directly attached to the maneuver knob 110. The key blade has an axial extension A1. The axial extension A1 of the key blade 120 substantially coincides with a direction of a movement of the lock operating device upon insertion into the electromechanical lock 200. The maneuver knob 110 has a front side 112 and a back side 114. The key blade 120 may be attached to the back side 114 of the maneuver knob 110, wherein the axial extension A1 of the key blade 120 is directed substantially perpendicular to a geometrical plane of the back side 114 of the maneuver knob 110. Should the front side 112 be curved, the front side 112 may be defined to have an average surface normal comprising a component directed away from the electromechanical lock 200 when the lock operating device 100 is in a use position, i.e., when the key blade 120 is inserted in the key-receiving portion. An analogous reasoning applies for the back side 114 of the maneuver knob 110. The key blade 120 is arranged to be inserted to an inserted state in a key-receiving portion 210 of the electromechanical lock 200. The lock operating device 100 thereby allows conversion of the electromechanical lock 200 between being arranged to, via the lock operating device 100, communicate authentication information wirelessly and being arranged to communicate authentication information with a programmable physical key inserted in the key-receiving portion 210 of the electromechanical lock 200. When the lock operating device 100 is inserted in the electromechanical lock 200, the back side 114 of the lock operating device 100 thereby faces towards the electromechanical lock 200 and the front side 112 of the lock operating device faces a user side, i.e., in practice, a side for receiving authentication information from the electronic device.

The key blade 120 of the lock operating device 100 may comprise fastening means arranged to mechanically fasten the key blade 120 within the key-receiving portion 210 in a fastened state. The key blade 120 and the key-receiving portion 210 being in such a fastened state may prevent unauthorized separation of the lock operating device 100 from the electromechanical lock 200. The fastening means may be a screw penetrating a hole extending substantially parallel to the axial extension A1 of the key blade 120 for engaging threads in a lock cylinder 212 of the electromechanical lock 200.

The key blade 120 and the key-receiving portion 210 may be fastened in the fastened state in response to locking the electromechanical lock 200. Hence, the lock operating device 100 may be securely fastened in the electromechanical lock while the electromechanical lock is in a locked state.

Unlocking the electromechanical lock 200 may allow setting the lock operating device 100 in a releasable state such that the lock operating device 100 may be conveniently separated from the electromechanical lock 200. This will be further explained in connection with the lock operating system 300 below.

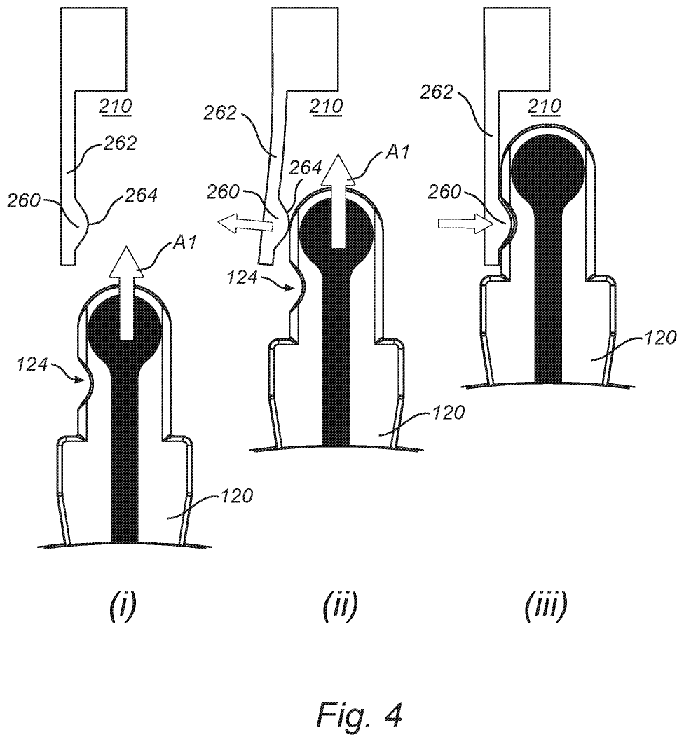

The key blade 120 may comprise an indentation 124. The indentation 124 is arranged to receive a geometrically complementary element located in the key-receiving portion 210 of the electromechanical lock 200. When the key blade 120 is in the inserted position in the electromechanical lock 200, the lock operating device 100 and the electromechanical lock 200 may be retained in a retained state. The retained state may be such that the lock operating device 100 can be unauthorizedly separated from the electromechanical lock 200 by applying at least a threshold force along the axial extension A1 of the key blade 210. The threshold force is to be understood possibly having a first component being parallel to the axial extension of the key blade, and a second component being perpendicular to the axial extension of the key blade. In practice, the second component may be small compared to the first component. This since a key blade is normally inserted or pulled out substantially along an axial extension of the key blade. This feature will be further described in connection with the lock operating system 300 below; see FIG. 4.

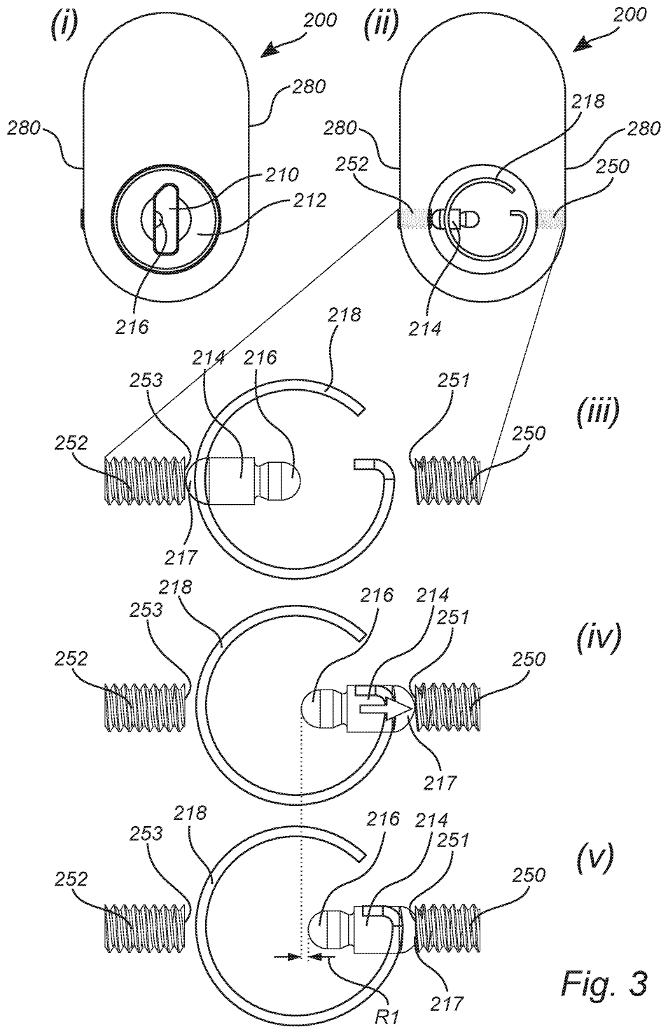

The key blade 120 may comprise a key-blade fastening element 122. The key-blade fastening element 122 will be further described in connection with FIG. 3 below.

The circuitry 130 of the lock operating device 100 may be arranged to, by electrical-power forwarding means 138, wirelessly transmit electrical power from an electronic device to the electromechanical lock 200. The electrical-power forwarding means 138 may include receiving electromagnetic energy from the electronic device by electromagnetic induction and forwarding a resulting electromagnetic current thereof to the electromechanical lock 200. The lock operating device 100 may hence comprise electronic components being exclusively passive. Hence, any own power supply, such as a battery, built into the lock operating device may be redundant.

The circuitry 130 of the lock operating device 100 may comprise Near Field Communication, NFC, means. The NFC means may allow either or both of authentication information and electrical power to we wirelessly transmitted between the electronic device 100 and the electromechanical lock 200. NFC may be used to induce electric currents within passive components and transfer data. Passive components, such as, e.g., the circuitry 130 of the lock operating device 100, may thereby be powered by an electromagnetic field generated by an active NFC component of the electronic device when the circuitry 130 of the lock operating device 100 is located within an adequate range of the active NFC component. Such a range is typically approximately 10 cm or less. It should be appreciated that any future equivalent of NFC, i.e., a communication means functioning similarly as NFC, may have, e.g., longer ranges. Hence, the lock operating device 100 may comprise any such a future equivalent of NFC. The active NFC component may be located in the electronic device. Encrypted data, i.e., authentication information, to be transferred between the electronic device and the electromechanical lock 200 may be sent by a data bit rate of, e.g., 106, 212, or 424 kilobits per second. The transmission frequency for data sent by NFC may be 13.56 megahertz or, if applicable, any adequate integer/divisible multiple thereof, the transmission frequency thereby lying in the radio-wave frequency range of the electromagnetic spectrum.

In connection with FIGS. 2A-2B, there is schematically shown a lock operating system 300. The lock operating system 300 comprises an electromechanical lock 200. The electromechanical lock 200 comprises a key-receiving portion 210. The electromechanical lock 200 comprises circuitry 230. The circuitry 230 comprises an authentication-information communicating function 232 arranged to communicate authentication information with an electronic device. The circuitry 230 comprises an electrical power receiving function 234 arranged to receive electrical power from the electronic device. The lock operating system 300 comprises a lock operating device 100. Structural and functional details of the lock operating device 100 are as described in connection with FIG. 1. To avoid undue repetition, reference is therefore made to the above. Below follows a further specification of an interplay between the lock operating device 100 and the electromechanical lock 200. FIG. 2A shows the lock operating system 300 while the lock operating device 100 is inserted in the electromechanical lock 200 in an inserted state. FIG. 2B shows the lock operating system 300 while the lock operating device 100 is separated from the electromechanical lock 200.

The key blade 120 of the lock operating device may comprise fastening means arranged to fasten the lock operating device 100 and the electromechanical lock 200 in a mutually fastened state. Any adequate type of fastening means may apply within the present scope of protection. The fastening means may be a screw (now shown) penetrating a hole (not shown) of the lock operating device 100 extending substantially parallel to the axial extension A1 of the key blade 120 for engaging threads (not shown) in the electromechanical lock 200. The screw may engage threads arranged to be rotated together with a rotation of the maneuver knob 110. That is, the threads are, in such a situation, located on a lock cylinder 212 of the electromechanical lock 200, the lock cylinder being rotatable about the axial extension A1 of the lock cylinder 212.

FIG. 3 schematically shows structural features of an example for fastening the lock operating device 100 to the electromechanical lock 200 while the electromechanical lock 200 is in a locked state. Within the following description of FIG. 3, reference regarding the structural features of the key blade 120 of the lock operating device 100 will be made.

As described mentioned, the lock operating device 100 may comprise a key-blade fastening element 122. The electromechanical lock 200 may comprise a complementary fastening element 214 complementary to the key-blade fastening element 122 such that the lock operating device 100 and the electromechanical lock 200 is fastened in a fastened state in response to locking the electromechanical lock 200. A “locked state” of the electromechanical lock 200 refers to a state where, provided the electromechanical lock 200 is mounted on a door of a building, the door is closed and locked, thus aiming to prevent unauthorized opening of the door. An example of how such a fastened state can be established in response to locking the electromechanical lock 200 follows below.

The electromechanical lock 200 may comprise a first configuration screw 250 and a second configuration screw 252; see FIGS. 3(ii)-(v). The configuration screws 250;252 engage radially extending threads of a lock body of the electromechanical lock 200. The configuration screws 250;252 are tightened perpendicular to an outer surface 280 of the electromechanical lock 200; see FIGS. 2A-2B. When the electromechanical lock 200 is in mounted position, the outer surface 280 of the electromechanical lock 200 is fixedly embedded in a geometrically complementary cavity (now shown) in, e.g., a door to such an axial extent that the screw heads of the configuration screws 250;252 are fixedly embedded in the geometrically complementary cavity. The configurations screws 250;252 are thereby to be mounted in the electromechanical lock 200 prior to mounting the electromechanical lock 200 on, e.g., a door. Hence, the configuration screws 250;252 are not removable from the electromechanical lock 200 unless the electromechanical lock 200 is at least partly removed from the door.

FIG. 3(i) shows the electromechanical lock 200 seen from a front side. FIG. 3(ii) shows the same electromechanical lock 200 where visibility of the lock cylinder 212 is turned off except for the parts located in a lock cylinder housing responsible for fastening the lock operating device 100 and the electromechanical lock 200. The complementary fastening element 214 of the electromechanical lock 200 may be biased in a radial direction of the lock cylinder 212 of the electromechanical lock 200 provided the complementary fastening element 214 is radially aligned with the first configuration screw 250 and the key blade 120 is inserted in the lock cylinder 212. The complementary fastening element 214 may be non-movable in the radial direction of the lock cylinder 212 provided the complementary fastening element 214 is radially aligned with the second configuration screw 252 and the key blade 120 is inserted in the lock cylinder 212, the key blade 120 and the key-receiving portion 210 thereby being mutually fastened while the fastening element 214 is non-movable in the radial direction of the lock cylinder 212. The key-blade fastening element 122 may be a recess 122; see FIG. 1. Such a recess 122 may have a geometry of a substantially spherical cap 122. The recess 122 has a recess depth (not shown). The key blade 120 may comprise an elongated channel 126 extending between the recess 122 and a tip 128 of the key blade 120. The elongated channel 126 may be a horizontal substantially cylindrical segment 126. The elongated channel 126 has a channel depth (not shown). The channel depth is smaller than the recess depth. The complementary fastening element 214 of the electromechanical lock 200 may hence comprise a protrusion 216 having an outer surface geometry complementary to the surface of the recess 122. That is, the protrusion 216 may in the present situation have a substantially spherical geometry arranged to be at least partly received by the recess 122 of the key blade 120. While inserting the key blade 120 in the key-receiving portion 210, the protrusion 216 slides along the elongated channel 126, eventually to be at least partly received by the recess 122 of the key blade 120. After the key blade 120 has been inserted in the key-receiving portion 210, the key blade 120 and the key-receiving portion 210 is mutually retained in a mutually retained state. In such a mutually retained state, the key blade 120 can be unauthorizedly removed from the key-receiving portion 210. The protrusion 216 is radially spring-loaded by a flexible ring-shaped element 218, wherein the ring-shaped element 218 forms a substantially circular outer geometry substantially along a circumferential path with respect to the lock cylinder 212. However, for a certain rotation angle of the lock cylinder 212, the protrusion 216 may be prevented from being spring loaded, i.e., non-movable in the radial extension of the lock cylinder 212. In such a certain rotation angle the key blade 120 may be fastened in the key-receiving portion 210 in a mutually fastened state. This functional feature may be achieved by the first configuration screw 252 and a second configuration screw 250. These configuration screws 250;252 may be located on radially opposing sides of the lock cylinder 212 and may be engaged in radially directed threads with respect to the lock cylinder 212, as described above. The second configuration screw 252 has a substantially flat end 253 facing a geometrical mantle of the lock cylinder 212. The complementary fastening element 214 may comprise a distal end 217 having a rounded geometry 217, such as a substantially spherical cap 217. When the rotation degree of the lock cylinder is such that the distal end 217 of the complementary fastening element 214 coincides with the flat end 253 of the first configuration screw 252, the complementary fastening element 214 is substantially non-movable in the radial extension of the lock cylinder 212. Such a rotation degree is referred to as a first rotation degree. This can be seen in FIG. 3 (iii). The second configuration screw 250 has a cup-shaped end 251 facing the geometrical mantle of the lock cylinder 212. When the rotation degree of the lock cylinder is such that the distal end 217 of the complementary fastening element 214 coincides with the cup-shaped end 253 of the second configuration screw 250, the complementary fastening element 214 may be movable in the radial extension of the lock cylinder 212 along a radially flexible distance R1. The radially flexible distance R1 is thereby equal to or larger than the difference between the recess depth of the recess 122 and the channel depth of the elongated channel 126. Such a rotation degree is referred to as a second rotation degree. For such a rotation degree, the lock operating device 100 is removable from the electromechanical lock 200. The angular difference between the first and the second rotation degree may be 180 degrees. This specific example may enable the key blade 120 of the lock operating device 100 being fastened in the key-receiving portion 210 of the electromechanical lock 200 in response to locking the electromechanical lock 200, whereas the lock operating device 100 is removable from the electromechanical lock 200 while the electromechanical lock 200 is in an unlocked state. However, in a situation where the electromechanical lock is to be unlocked by a programmable physical key, the programmable physical key is removable from the electromechanical lock also when the electromechanical lock has been locked, as is normal for physical keys in general. Hence, the discussion regarding the first 250 and the second 252 configuration screws above does in general not apply for the programmable physical key. It is to be understood that both configuration screws 250;252 in such a situation may, e.g., have cup-shaped ends 253 according to the above. It should further be readily appreciated that the configurations screws 250;252 may be configured to allow the lock operating device 100 and the electromechanical lock 200 to be fastened while the electromechanical lock 200 is in an unlocked state, whereas the lock operating device 100 may be removable while the electromechanical lock 200 is in a locked state.

The key blade 120 may comprise a key-blade fastening element for receiving a fastening element of the electromechanical lock 200 to fasten the lock operating device 100 and the electromechanical lock 200 in a fastened state, the fastening element being actuated upon communication of valid authentication information with the electronic device. Hence, the lock operating device 100 may be fastened to the electromechanical lock 200 upon actuation of a fastening means by the electronic device. Such an actuation may include an actuator pin (not shown), located in the electromechanical lock 200, and a complementary through-going hole (not shown), cavity or indentation on the key blade 120, the actuator pin being actuated upon communication of valid authentication information between the electronic device and the electromechanical lock 200. The authentication information as described here may be different from the authentication information required to unlock the electromechanical lock 200. The lock operating device 100 may in such a situation be fastened to prevent unauthorized separation of the lock operating device 100 and the electromechanical lock 200 when the electromechanical lock 200 is in the unlocked state and/or when the electromechanical lock 200 is in a locked state.

According to an embodiment, the key blade 120 may be fastened in the key-receiving portion 210 by lockingly expanding the key blade 120 when the key blade 120 is inserted in the key-receiving portion 210. Such a lockingly expansion may include a selectively pivotable portion (not shown) attached on the key blade 120 to be pivotably extended while the key blade 120 is inserted in the key-receiving portion 210 to prevent unauthorized removal of the key blade 120. One example of such a selectively pivotable portion is a barb coupling.

In connection with FIG. 4, there is schematically described an example of how the lock operating device 100 may be attached to the electromechanical lock 200. FIG. 4(i) shows the key blade 120 of the lock operating device 100 while being inserted in the electromechanical lock along the axial extension A1 of the key blade 120. FIG. 4(ii) shows the key blade 120 while being partly inserted in the electromechanical lock 200. FIG. 4(iii) shows the key blade when inserted in the electromechanical lock. The key blade 120 may comprise an indentation 124. The indentation 124 is configured to receive a geometrically complementary element 260 located in the key-receiving portion 210 of the electromechanical lock 200. When the key blade 120 is in the inserted position in the electromechanical lock 200, the lock operating device 100 and the electromechanical lock 200 may be mutually retained in a mutually retained state. The indentation 124 of the key blade 120 may have any adequate geometry to receive the geometrically complementary element 260 of the electromechanical lock 200. The geometrically complementary element 260 may be a flexible arm 262, as shown in FIG. 4, having a protrusion 264 that at least partly is to be received by the indentation 124 of the key blade 120. The geometrically complementary element 260 may alternatively be a spring-loaded ball, magnetic means, or the like. The geometrically complementary element 260 may be any adequate flexible protruding portion or part to be received by the indentation 124 of the key blade 120. However, an opposite arrangement is possible in that the key blade 120 may comprise either of the described complementary elements 260, whereas the indentation 124 is located in the lock cylinder 212 the electromechanical lock 200. The lock operating device 100 may be released from the electromechanical lock by applying at least a threshold force along the axial extension A1 of the key blade 120. The magnitude of the threshold force may be such that the lock operating device 100 is firmly secured in the electromechanical lock 200, though yet to be released with hand power if desired.

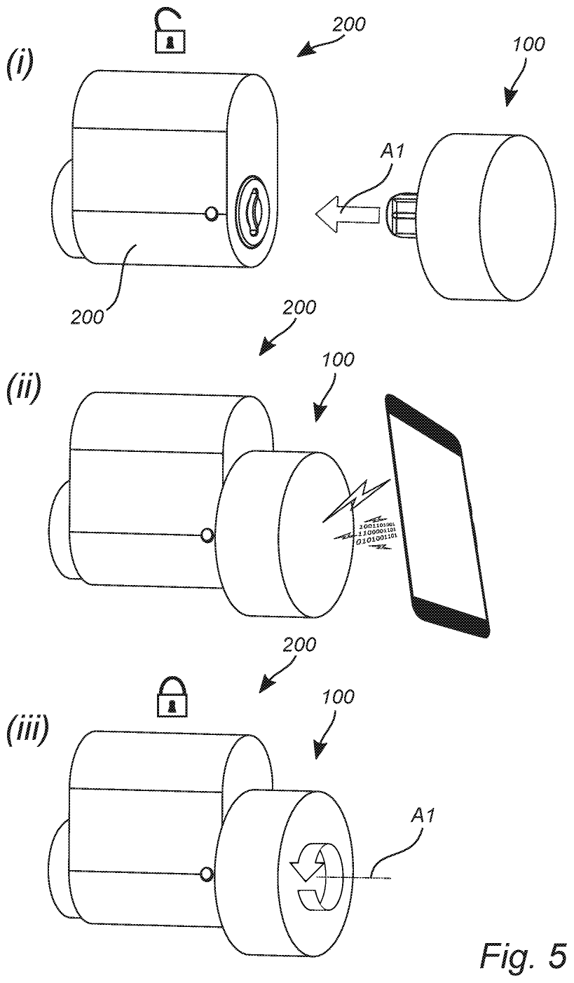

In connection with FIG. 5, there is pictorially shown an exemplifying procedure for setting the electromechanical lock 200 in a locked state by utilizing the lock operating device 100. In FIG. 5(i) the lock operating device 100 is inserted in the electromechanical lock 200. If the lock operating device 100 is configured to be fastened in the electromechanical lock 200 in a mutually fastened state while the electromechanical lock 200 is in a locked state, the electromechanical lock 200 is in an unlocked state upon insertion of the key blade 120. In FIG. 5(ii) there is schematically shown wireless communication of electrical power and authentication information between an electronic device and the electromechanical lock 200 via the lock operating device 100. Provided the electromechanical lock 200 has received valid authentication information from the electronic device, the electromechanical lock 200 is arranged to be set in a locked state by rotating the lock operating device 100 about an axial extension A1 of the key blade 120 when the key blade 120 is inserted in the key-receiving portion 210 of the electromechanical lock 200; see FIG. 5 (iii). That is, the physical movement of a user when unlocking the electromechanical lock 200 by rotating the lock operating device 100 is substantially similar to when unlocking the electromechanical lock 200 by a programmable physical key.

Additional details of an example of the structural features of the lock cylinder 212 of the electromechanical lock will now follow. Several of the following parts of the lock cylinder are not shown in the set of appended drawings. The lock cylinder 212 of the electromechanical lock may comprise an annular element being rotatably and axially moveably mounted on the lock cylinder, wherein a blocking arrangement comprises a retaining device arranged to prevent the annular element from rotating together with the lock cylinder when the lock cylinder 212 is rotated with an inappropriate key, by engaging the axially moveable annular element with a stationary element. Such a lock cylinder 212 comprises an actuator to actuate a pin to be received by a recess in the axially moveable annular element a for allowing engagement of the annular element and the lock cylinder 212, upon an appropriate programmable physical key is inserted or upon a valid authentication information has been received.

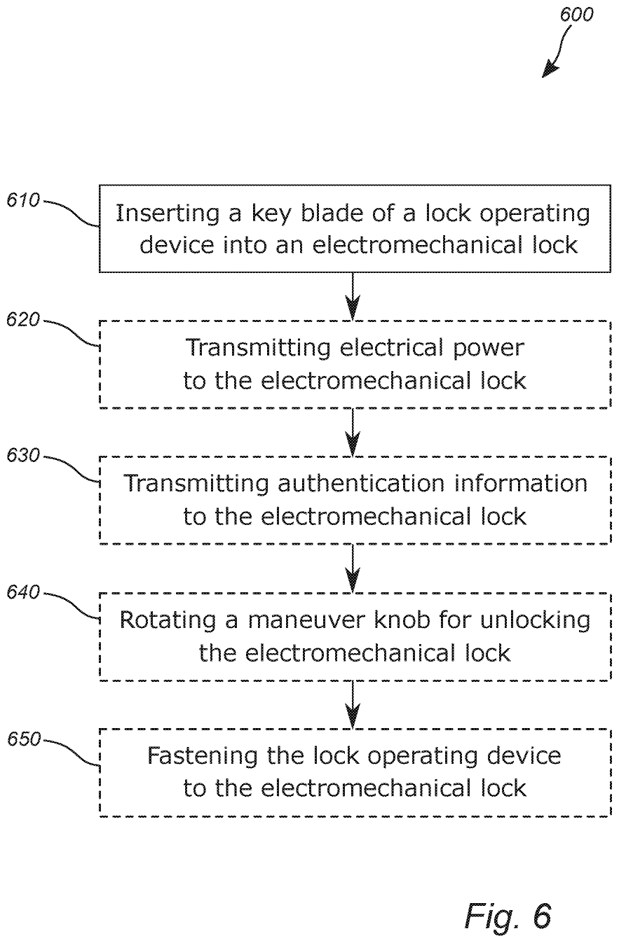

In connection with FIG. 6, there is described a method 600 for converting an electromechanical lock 200 from a first operating mode in which the electromechanical lock 200 can be operated by a programmable physical key receivable in a key-receiving portion 210 of the electromechanical lock 200, to a second operating mode. The method 600 comprises inserting a key blade 120 of a lock operating device 100 into the key-receiving portion 210.

The lock operating device 100 comprises circuitry 130 which includes wireless communication means arranged to wirelessly receive authentication information. The circuitry 130 is arranged to communicate the received authentication information to the electromechanical lock 200 via the inserted key blade 120.

The first operating mode thereby refers to a capability of unlocking the electromechanical lock 200 by using the programmable physical key.

The second operating mode thereby refers to a capability of unlocking the electromechanical lock 200 by using the lock operating device 100 and an electronic device.

The features of the lock operating device 100 and the electromechanical lock 200 are as described above. To avoid undue repetition, reference is hence made to the above when applicable.

The method 600 may comprise transmitting 620 electrical power to the electromechanical lock 200.

The method 600 may comprise wirelessly transmitting 630 authentication information between an electronic device and the lock operating device 100.

The method 600 may comprise rotating 640 a maneuver knob 110 of the lock operating device 100 about an axial extension A1 of the key blade 120 for unlocking the electromechanical lock 200.

The method 600 may comprise fastening 650 the lock operating device 100 to the electromechanical lock 200 in a mutually fastened state to prevent unauthorized separation of the lock operating device 100 and the electromechanical lock 200.

Accordingly, and in summary, a lock operating device, a system, and a method thereof have been disclosed. The lock operating device 100 may provide for a convenient approach for converting an ordinary electromechanical lock, operated by a programmable physical key, to a wirelessly operated lock, operated by, e.g., a smartphone. When the lock operating device is in an inserted position in an electromechanical lock, the electromechanical lock may be locked/unlocked by the smartphone. This by communicating both authentication and electrical power (by, e.g., NFC) between the smartphone and the electromechanical lock. However, alternatively, the lock operating device may comprise its own power source, e.g., a battery. In such a situation, only authentication information may be communicated between the smartphone and the electromechanical lock (by, e.g., a passive RFID tag). The present disclosure may provide for a relatively cheap and simple conversion of the electromechanical lock between the operating modes set out above and below.

Other features and embodiments of the electronic device may be applicable to the above-mentioned specification of the device, the system, and the method.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims.

1. A lock operating device configured to be retrofitted on an electromechanical lock having a key-receiving portion, said lock operating device comprising:
a maneuver knob,
a key blade being operably connected to the maneuver knob and being insertable in said key-receiving portion of the electromechanical lock, and circuitry which includes wireless communication means arranged to wirelessly receive authentication information, and which circuitry is arranged to communicate the received authentication information to the electromechanical lock via the inserted key blade,
wherein the lock operating device thereby allows conversion of the electromechanical lock from a first operating mode, in which the electromechanical lock can be operated by a programmable physical key receivable in said key-receiving portion, to a second operating mode in which the electromechanical lock is arranged to receive said authentication information wirelessly and be operated by the maneuver knob.

2. The lock operating device according to claim 1, wherein the circuitry is arranged to transmit electrical power to the electromechanical lock.

3. The lock operating device according to claim 1, wherein the key blade comprises fastening means arranged to mechanically fasten the key blade within the key-receiving portion in a fastened state, thereby preventing unauthorized separation of the lock operating device from the electromechanical lock.

4. The lock operating device according to claim 1, wherein the lock operating device and the electromechanical lock are arranged to be fastened in the fastened state in response to locking the electromechanical lock.

5. The lock operating device according to claim 1, wherein the key blade comprises an indentation for receiving a geometrically complementary element located in the electromechanical lock, the indentation and the geometrically complementary element being arranged to retain the lock operating device and the electromechanical lock in a retained state while the key blade is inserted in the key-receiving portion, wherein the retained state is such that the lock operating device can be unauthorizedly separated from the electromechanical lock by applying at least a threshold force along an axial extension of the key blade.

6. The lock operating device according to claim 1, wherein the circuitry is arranged to wirelessly transmit electrical power from an electronic device to the electromechanical lock.

7. The lock operating device according to claim 1, wherein the circuitry comprises Near Field Communication, NFC, means to allow either or both of authentication information and electrical power to be wirelessly transmitted from the electronic device to the electromechanical lock.

8. The lock operating device according to claim 1, wherein the lock operating device comprises a battery or an electric generator.

9. A lock operating system, comprising an electromechanical lock having a key receiving portion, and a lock operating device according to claim 1.

10. The lock operating system according to claim 9, wherein the key blade comprises fastening means according to claim 3, arranged to mutually fasten the lock operating device and the electromechanical lock in a mutually fastened state, thereby preventing unauthorized separation of the lock operating device and the electromechanical lock.

11. The lock operating system according to claim 9, wherein the key blade comprises a key-blade fastening element according to claim 3, and wherein the electromechanical lock comprises a complementary fastening element complementary to the key-blade fastening element, for setting the lock operating device and the electromechanical lock in a mutually fastened state in response to locking the electromechanical lock, thereby preventing unauthorized separation of the lock operating device and the electromechanical lock.

12. The lock operating system according to claim 9, wherein the electromechanical lock comprises a first configuration screw, a second configuration screw and a lock cylinder, and wherein the complementary fastening element is biased in a radial direction of the lock cylinder provided the complementary fastening element is radially aligned with the first configuration screw and the key blade is inserted in the lock cylinder, and wherein the complementary fastening element is non-movable in the radial direction of the lock cylinder provided the complementary fastening element is radially aligned with the second configuration screw and the key blade is inserted in the lock cylinder, the lock operating device and the electromechanical lock thereby being mutually fastened while the complementary fastening element is non-movable in the radial direction of the lock cylinder.

13. The lock operating system according to claim 9, wherein the key blade comprises a key-blade fastening element for receiving a fastening element of the electromechanical lock to fasten the lock operating device and the electromechanical lock in a mutually fastened state, the fastening element of the electromechanical lock being actuated in response to receiving valid authentication information from the electronic device.

14. The lock operating system according to claim 9, wherein the key blade comprises an indentation according to claim 5, and wherein the key-receiving portion comprises a geometrically complementary element, the indentation and the geometrically complementary element being arranged to be mutually retained in a mutually retained state while the key blade is inserted in the key-receiving portion, wherein the mutually retained state is such that the lock operating device can be unauthorizedly separated from the electromechanical lock by applying at least a threshold force on the lock operating device, the threshold force being parallel to an axial extension of the key blade.

15. The lock operating system according to claim 9, wherein the electromechanical lock is, provided the electromechanical lock has received valid authentication information from the electronic device, arranged to be set in an unlocked state by rotating the lock operating device about the axial extension of the key blade when the key blade is inserted in the key-receiving portion.

16. A method for converting an electromechanical lock from a first operating mode in which the electromechanical lock can be operated by a programmable physical key receivable in a key-receiving portion of the electromechanical lock, to a second operating mode, said method comprising:
inserting a key blade of a lock operating device into said key-receiving portion, said lock operating device comprising circuitry which includes wireless communication means arranged to wirelessly receive authentication information, and which circuitry is arranged to communicate the received authentication information to the electromechanical lock via the inserted key blade.

17. The method according to claim 16, further comprising transmitting electrical power to the electromechanical lock.

18. The method according to claim 16, further comprising
wirelessly transmitting authentication information between an electronic device and the lock operating device.

19. The method according to claim 16, further comprising rotating a maneuver knob of the lock operating device about an axial extension of the key blade for unlocking the electromechanical lock.

20. The method of claim 16, further comprising fastening the lock operating device to the electromechanical lock in a mutually fastened state to prevent unauthorized separation of the lock operating device and the electromechanical lock.
